(19) United States
(12) Patent Application Publication
(10) Pub. No.: US 2025/0227566 A1
(43) Pub. Date: Jul. 10, 2025

(54) Primary Secondary Cell Handover in Unlicensed Spectrum

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Saratoga, CA (US)

(21) Appl. No.: 18/853,357

(22) PCT Filed: Apr. 22, 2022
(86) PCT No.: PCT/CN2022/088405

§ 371 Date: Oct. 1, 2024

(51) Int. Cl. H04W 36/00; H04W 36/08; H04W 74/0833

(52) U.S. Cl. CPC H04W 36/0069; H04W 36/08; H04W 74/0833

(57) ABSTRACT

This disclosure relates to techniques for performing handover for a primary cell of a secondary cell group in unlicensed spectrum in a wireless communication system. A wireless device may establish a dual connectivity cellular link with a cellular network. An indication may be received by the wireless device to perform handover of the primary cell of the secondary cell group in an unlicensed frequency band. The wireless device may determine whether to increase a preamble transmission counter for a physical random access channel occasion on the target primary secondary cell if the occasion conflicts with a random access channel procedure on the primary cell of the master cell group. The wireless device may also determine whether to increase the preamble transmission counter for a physical random access channel occasion on the target primary secondary cell if the occasion is unavailable due to an unsuccessful listen-before-talk procedure.

### PRIORITY INFORMATION

This application is a national stage entry of PCT Application No. PCT/CN2022/088405, entitled “Primary Secondary Cell Handover in Unlicensed Spectrum,” filed Apr. 22, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for performing handover for a primary cell of a secondary cell group in unlicensed spectrum in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, CHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing handover for a primary cell of a secondary cell group in unlicensed spectrum in a wireless communication system.

According to the techniques described herein, a wireless device may be able to determine under which conditions to increase the preamble transmission counter for performing a random access channel procedure for handover to a target primary cell of a secondary cell group in unlicensed spectrum. This may include determining whether to increase the preamble transmission counter in a scenario in which a physical random access channel occasion is unavailable due to an unsuccessful uplink listen before talk procedure. This may also or alternatively include determining whether to increase the preamble transmission counter in a scenario in which a physical random access channel occasion is unavailable due to a time domain conflict with a random access channel procedure for handover to a target primary cell of a master cell group. The determination may be based on configuration information from the cellular network, and/or may be based on technical specifications for a radio access technology according to which the wireless device operates, as various possibilities.

Techniques are also described herein for a wireless device to determine whether to prioritize a physical random access channel occasion associated with a target primary cell of a master cell group or a physical random access channel occasion associated with a target primary cell of a secondary cell group during such a handover, for example in a scenario in which power limitations prevent the wireless device from transmitting during the time-conflicted physical random access channel occasions. Additionally, techniques are described herein for handling radio frequency re-tuning from a target primary cell of a secondary cell group during a handover for which an associated timer has expired.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments; and

FIG. 5 is a flowchart diagram illustrating aspects of an exemplary possible method for performing handover for a primary cell of a secondary cell group in unlicensed spectrum in a wireless communication system, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
3GPP: Third Generation Partnership Project
GSM: Global System for Mobile Communication
UMTS: Universal Mobile Telecommunication System
LTE: Long Term Evolution
E-UTRAN: Evolved Universal Terrestrial Radio Access Network
NR: New Radio
EN-DC: E-UTRAN-NR Dual Connectivity
TX: Transmission/Transmit
RX: Reception/Receive
RAT: Radio Access Technology
TRP: Transmission-Reception-Point
RRC: Radio Resource Control
MAC: Media Access Control
DCI: Downlink Control Information.
RACH: Random Access Channel
PRACH: Physical Random Access Channel

### Terms

The Following is a Glossary of Terms that May Appear in the Present Disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

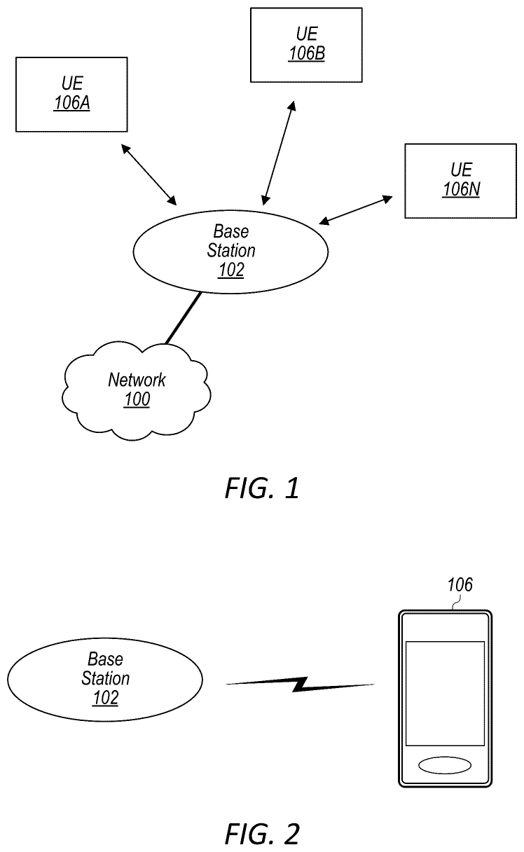

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘cNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, cHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform handover for a primary cell of a secondary cell group in unlicensed spectrum in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a handheld device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

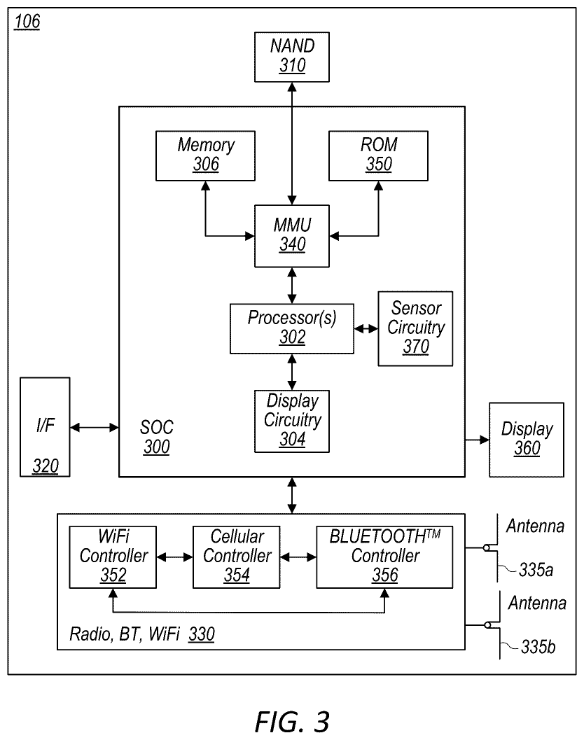

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform handover for a primary cell of a secondary cell group in unlicensed spectrum in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform handover for a primary cell of a secondary cell group in unlicensed spectrum in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

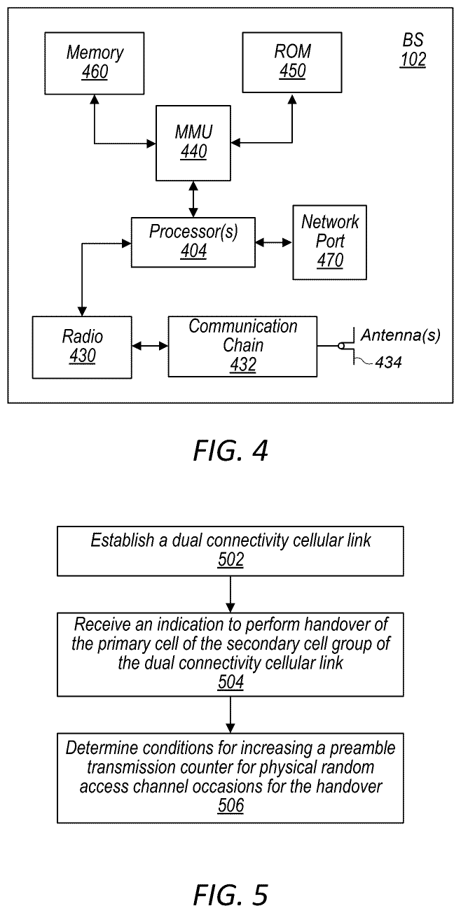

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of NixR matrixes may be defined (e.g., where R represents the number of layers, N, represents the number of transmitter antenna ports, and N represents the size of the codebook). In such a scenario, the number of transmission layers (R) may conform to a rank value of the precoding matrix (N, XR matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### FIG. 5—Primary Secondary Cell Handover in Unlicensed Spectrum

3GPP 5G communication techniques can include the possibility of dual connectivity cellular communication links, for example in which a wireless device can connect with both a master cell group (MCG) and a secondary cell group (SCG), potentially including scenarios in which the different cell groups operate according to different cellular communication technologies, such as LTE and NR. Furthermore, it may be possible that some cells in such a system operate in unlicensed spectrum, which can potentially require the use of certain variations or extensions of a cellular communication technology, such as in the case of NR-U.

Since mobility may generally be an important aspect of cellular communication, providing techniques for handling handover that can account for the complexities of dual connectivity cellular links, including when there is the possibility of one or more cells operating in unlicensed spectrum, may be important to ensuring smooth user experience, among other possible benefits, at least according to some embodiments.

Accordingly, it may be beneficial to specify techniques for performing handover for a primary cell of a secondary cell group in unlicensed spectrum. To illustrate one such set of possible techniques, FIG. 5 is a flowchart diagram illustrating a method for performing handover for a primary cell of a secondary cell group in unlicensed spectrum in a wireless communication system, at least according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may establish a dual connectivity cellular link. As part of the dual connectivity cellular link, the wireless device may establish wireless links with one or more cellular base stations. According to some embodiments, the wireless links may include a cellular link according to 5G NR. For example, the wireless device may establish a session with an AMF entity of the cellular network by way of one or more gNBs that provide radio access to the cellular network. As another possibility, the wireless links may include a cellular link according to LTE. For example, the wireless device may establish a session with a mobility management entity of the cellular network by way of an eNB that provides radio access to the cellular network. As one example, the dual connectivity link may include an EN-DC link in which a master cell group for the wireless device operates according to LTE and a secondary cell group for the wireless device operates according to NR. The cells may be provided by the same cellular base station or different cellular base stations, according to various embodiments. Other types of cellular links are also possible, and the cellular network may also or alternatively operate according to another cellular communication technology (e.g., UMTS, CDMA2000, GSM, etc.), according to various embodiments.

Establishing a wireless link may include establishing a RRC connection with a serving cellular base station via a (e.g., primary or secondary) cell provided by the cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 504, the wireless device may receive an indication to perform handover. The handover may at least include handover of a primary cell of the secondary cell group of the dual connectivity cellular link. The primary cell of the secondary cell group may also be referred to herein as a “primary secondary cell,” or “PSCell,” at least according to some embodiments. In some instances, the handover may also include handover of a primary cell of the master cell group of the dual connectivity cellular link. The primary cell of the master cell group may also be referred to herein as a “primary cell,” or “PCell,” at least according to some embodiments. For example, the handover could be a EN-DC to EN-DC handover.

Note that the primary cell and the primary secondary cell from which handover is performed, respectively, may be referred to herein as the “source primary cell” (or as a “first cell”) and the “source primary secondary cell” (or as a “second cell”), respectively. Similarly, the primary cell and the primary secondary cell to which handover is performed, respectively, may be referred to herein as the “target primary cell” (or as a “third cell”) and the “target primary secondary cell” (or as a “fourth cell”), respectively. In at least some embodiments, the target primary secondary cell may operate on an unlicensed frequency band. It may also be possible that one or more other cells involved in the handover (e.g., the source primary secondary cell, as one possibility) also operate on an unlicensed frequency band, in some instances. At least in some instances, the target primary cell may operate on a licensed frequency band. It may also be possible that one or more other cells involved in the handover (e.g., the source primary cell, as one possibility) also operate on a licensed frequency band, in some instances.

Performing the handover may include attempting to perform a preamble transmission during a physical random access channel (PRACH) occasion on the target primary secondary cell. If successful, a RACH procedure may be performed on the target primary secondary cell as part of a successful handover. If a preamble transmission is unsuccessful on a PRACH occasion for the target primary secondary cell, it may be the case that a preamble transmission counter is increased (e.g., up to a configured maximum number), and the wireless device may perform one or more subsequent attempts (possibly with increased transmit power) on one or more subsequent PRACH occasions for the target primary cell (e.g., provided the preamble transmission counter is not already at the configured maximum number or a timer associated with the handover hasn't reached expiry).

There may also be possible scenarios in which a PRACH occasion is considered unavailable, potentially preventing the wireless device from performing a preamble transmission during a PRACH occasion for the target primary secondary cell. For example, if a PRACH occasion for the target primary secondary cell conflicts in the time domain with a PRACH occasion on the primary cell, it may be possible that the PRACH occasion for the target primary secondary cell is deprioritized and considered unavailable (e.g., due to power limitations at the wireless device). As another possibility, if an uplink listen-before-talk (LBT) procedure for the frequency channel of the target primary secondary cell fails for a PRACH occasion for the target primary secondary cell (e.g., if the wireless medium is already in use), it may be the case that the PRACH occasion for the target primary secondary cell is considered unavailable. For consistent operation, it may be useful to provide techniques for a wireless device to determine whether to increase the preamble transmission counter during such scenarios.

In 506, the wireless device may determine conditions for increasing a preamble transmission counter for PRACH occasions for the handover. This may include determining whether to increase the preamble transmission counter for a PRACH occasion on the target primary secondary cell if the PRACH occasion is unavailable for PRACH transmission due to an unsuccessful uplink LBT procedure, and/or determining whether to increase the preamble transmission counter for a PRACH occasion on the target primary secondary cell if the PRACH occasion is unavailable for PRACH transmission due to the PRACH occasion conflicting in the time domain with a PRACH transmission on the (e.g., target) primary cell of the master cell group.

In some instances, the determination may be based on behavior specified in 3GPP technical specifications. For example, as one possibility, it may be specified that a wireless device increases the preamble transmission counter when a target primary secondary cell PRACH occasion is unavailable due to an unsuccessful uplink LBT procedure, but does not increase the preamble transmission counter when a target primary secondary cell PRACH occasion is unavailable due the target primary secondary cell PRACH occasion being deprioritized to be unavailable due to power limitations if the target primary secondary cell PRACH occasion conflicts in the time domain with a primary cell RACH procedure. As another possibility, it may be specified that a wireless device increases the preamble transmission counter when a target primary secondary cell PRACH occasion is unavailable due to an unsuccessful uplink LBT procedure, and also increases the preamble transmission counter when a target primary secondary cell PRACH occasion is unavailable due the target primary secondary cell PRACH occasion being deprioritized to be unavailable due to power limitations if the target primary secondary cell PRACH occasion conflicts in the time domain with a primary cell RACH procedure. Other specified behaviors are also possible.

As a further possibility, the cellular network may provide configuration information to indicate whether to increase the preamble transmission counter when a target primary secondary cell PRACH occasion is unavailable due to an unsuccessful uplink LBT procedure, and/or whether to increase the preamble transmission counter when a target primary secondary cell PRACH occasion is unavailable due to the target primary secondary cell PRACH occasion being deprioritized to be unavailable due to power limitations if the target primary secondary cell PRACH occasion conflicts in the time domain with a primary cell RACH procedure. Such configuration information could be provided using any of various possible types of signaling at any of various possible protocol layers (e.g., via broadcast system information, radio resource control (RRC) signaling, media access control (MAC) control element (CE) signaling, downlink control information (DCI) signaling, etc.), according to various embodiments.

Note that it may also be possible that whether the target primary secondary cell PRACH occasion is deprioritized to be unavailable due to power limitations if the target primary secondary cell PRACH occasion conflicts in the time domain with a primary cell RACH procedure can vary, e.g., based at least in part on the value of the preamble transmission counter. For example, it may be desirable to prioritize a target primary secondary cell PRACH occasion over a primary cell RACH procedure that conflicts in the time domain if the preamble transmission counter has already reached a configured threshold value (e.g., but is less than the configured counter maximum value), e.g., to increase the chance of successfully performing a RACH procedure on the target primary secondary cell before reaching the configured maximum number of preamble transmission attempts or otherwise reaching a timer expiry for the handover.

Thus, as one possibility, it may be the case that a wireless device (e.g., with power limitations preventing both transmissions) can determine whether to prioritize PRACH transmission on the primary cell of the master cell group or PRACH transmission on the primary cell of the secondary cell group when a PRACH occasion for the primary cell of the master cell group conflicts in the time domain with a PRACH occasion for the primary cell of the secondary cell group based at least in part on a current value of the preamble transmission counter for the primary cell of the secondary cell group. For example, for such a device, PRACH transmission on the primary cell of the master cell group may be prioritized over PRACH transmission on the primary cell of the secondary cell group when a PRACH occasion for the primary cell of the master cell group conflicts in the time domain with a PRACH occasion for the primary cell of the secondary cell group if the current value of the preamble transmission counter is less than a counter threshold, and PRACH transmission on the primary cell of the secondary cell group may be prioritized over PRACH transmission on the primary cell of the master cell group when a PRACH occasion for the primary cell of the master cell group conflicts in the time domain with a PRACH occasion for the primary cell of the secondary cell group if the current value of the preamble transmission counter is equal to or greater than the counter threshold.

The value of the counter threshold for such determination may be specified in 3GPP technical specifications, or may be configured by the cellular network, for example via broadcast system information, RRC signaling, MAC CE signaling, DCI signaling, etc., according to various embodiments. At least in some instances, the value of the counter threshold may be configured to be less than a value configured as a maximum number of random access preamble transmissions for the primary secondary cell handover (e.g., a preambleTransMax parameter, as one possibility).

Another aspect of handling such a dual connectivity handover may include providing techniques for scenarios in which the handover is unsuccessful. For example, during handover of a primary secondary cell in an EN-DC to EN-DC scenario, if a timer associated with the handover (e.g., a T304 timer according to 3GPP) reaches expiry, it may be useful to provide techniques for handling re-tuning from the target primary secondary cell (e.g., to leave the primary secondary component carrier). Such behavior may be specified or configured by the cellular network, according to various embodiments. As one possibility, the wireless device may determine to perform radio frequency re-tuning from the target primary secondary cell on symbols that are not overlapped with control or data channels, RACH occasions, or downlink or uplink reference signals of the primary cell of the master cell group. As another possibility, the wireless device may determine to perform radio frequency re-tuning from the target primary secondary cell on symbols that are not overlapped with RACH occasions of the primary cell of the master cell group (e.g., re-tuning may be performed on symbols that are overlapped with control or data channels or downlink or uplink reference signals of the primary cell of the master cell group). In some instances, the wireless device may transmit a message to the cellular network indicating that addition of the fourth cell as the primary cell of the secondary cell group has failed (e.g., a primary secondary cell addition failure message) prior to such re-tuning. In other words, in such a scenario, the radio frequency re-tuning from the target primary secondary cell may be performed after the message indicating that addition of the fourth cell as the primary cell of the secondary cell group has failed is transmitted to the cellular network.

Thus, at least according to some embodiments, the method of FIG. 5 may be used to provide a framework according to which a wireless device can be configured to perform handover for a primary cell of a secondary cell group that operates on an unlicensed frequency channel, and thus to assist a cellular network to smoothly and effectively handle wireless device mobility including in such a dual connectivity scenario that uses unlicensed spectrum, at least in some instances.

### Additional Information

The following additional information is provided to illustrate further aspects that might be used in conjunction with the method of FIG. 5 if desired. It should be noted, however, that these exemplary details are not intended to be limiting to the disclosure as a whole: numerous variations and alternatives to the details provided herein below are possible and should be considered within the scope of the disclosure.

In a Evolved Universal Terrestrial Radio Access-New Radio Dual Connectivity (EN-DC) wireless communication system, a UE may establish cellular links with both a LTE eNB and a NR gNB, with the LTE eNB providing a master cell group (MCG) and the NR gNB providing a secondary cell group (SCG), at least according to some embodiments. There may be a primary cell (PCell) configured for the MCG as well as a primary secondary cell (PSCell) configured for the SCG. When handover from EN-DC to EN-DC is performed, it may be the case that the delay to change from the source NR PSCell to the target PSCell is configured to be limited to less than a configured handover delay value, e.g., or otherwise may the handover may be considered to be unsuccessful. As one possibility, the configured handover delay value may be calculated according to the following formula.

$${D}_{HOwithPSCell\_PSCell} = {T}_{RRC\_delay} + {T}_{processing} + {T}_{search} + {T}_{Δ} + {T}_{PSCell\_DU} + {T}_{PCell\_DU} + 2 ms$$

where T_{RRC_delay} is a specified or configured maximum RRC procedure delay value, T_{processing} is a specified or configured software processing time needed by the UE (e.g., 25 ms if source NR PSCell and target NR PSCell are in the same frequency range, or 45 ms if source NR PSCell and target NR PSCell are in different frequency ranges, as one possibility), T_{search} may be determined in a similar manner as T_{search} in 3GPP TS 36.133 v.17.4.0 section 7.31.2, T_{Δ} may be determined in a similar manner as T_{Δ} in 3GPP 36.133 v.17.4.0 section 7.31.2, T_{pscell Du} may be determined in a similar manner as T_{pscell Du} in 3GPP 36.133 v.17.4.0 section 7.31.2, and T_{pcell Du} may be the delay uncertainty due to PCell RACH preamble transmission defined in 3GPP TS 38.213 v.17.0.0. For example, in 3GPP TS 36.133 v.17.4.0 section 7.31.2, it is defined that T_{pscell DU} is the delay uncertainty in acquiring the first available PRACH occasion in the NR PSCell. T_{pscell pu} is up to the summation of SSB to PRACH occasion association period and 10 ms. The SSB to PRACH occasion association period may be defined in the table 8.1-1 of TS 38.213 v.17.0.0.

When a NR PSCell in a handover from EN-DC to EN-DC is operating on an unlicensed frequency band, it may also be important to consider the delay or uncertainty due to listen-before-talk (LBT) failure. The PSCell random access channel (RACH) uncertainty may include the RACH uncertainty due to possible collision between PCell RACH and PSCell RACH, and RACH delay due to uplink LBT failure at the UE. There may be multiple possibilities for which components are counted in the PREAMBLE_TRANSMISSION_COUNTER, which may be the counter for RACH preamble transmission. At least in some embodiments, a UE may behave in accordance with the behavior specified in 3GPP TS 38.321 v.16.7.0 section 5.1.3 after this counter is reached.

As one possibility, during PSCell handover for EN-DC to EN-DC, for the RACH transmission on the new (target) PSCell, it may be the case that the PREAMBLE_TRANSMISSION_COUNTER is only increased when a PSCell PRACH occasion is unavailable for PRACH transmission due to uplink LBT failure at the UE. In such a scenario, the PREAMBLE_TRANSMISSION_COUNTER may remain unchanged when a PSCell PRACH occasion is deprioritized and considered unavailable due to power limitations (e.g., if PCell RACH and PSCell RACH are colliding in the time domain) but no LBT failure is observed for the PSCell PRACH transmission, at least according to some embodiments. The UE behavior when the PREAMBLE_TRANSMISSION_COUNTER reaches the preambleTransMax may be performed in accordance with the behavior specified in TS 38.321 v16.7.0 section 5.1.3, at least as one possibility.

As another possibility, during PSCell handover for EN-DC to EN-DC, for the RACH transmission on the new (target) PSCell, it may be the case that the PREAMBLE_TRANSMISSION_COUNTER is increased when either or both of a PSCell PRACH occasion is unavailable for PRACH transmission due to uplink LBT failure at the UE, and/or when a PSCell PRACH occasion is deprioritized and considered unavailable due to power limitations (e.g., if PCell RACH and PSCell RACH are colliding in the time domain), at least according to some embodiments. The UE behavior when the PREAMBLE_TRANSMISSION_COUNTER reaches the preambleTransMax may be performed in accordance with the behavior specified in TS 38.321 v16.7.0 section 5.1.3, at least as one possibility.

As a further possibility, during PSCell handover for EN-DC to EN-DC, for the RACH transmission on the new (target) PSCell, it may be the case that the network indicates to the UE how to count the PREAMBLE_TRANSMISSION_COUNTER. This may include providing an indication of whether to increase the PREAMBLE_TRANSMISSION_COUNTER when a PSCell PRACH occasion is unavailable for PRACH transmission due to uplink LBT failure at the UE, and/or an indication of whether to increase the PREAMBLE_TRANSMISSION_COUNTER when a PSCell PRACH occasion is deprioritized and considered unavailable due to power limitations (e.g., if PCell RACH and PSCell RACH are colliding in the time domain), at least according to some embodiments. The UE behavior when the PREAMBLE_TRANSMISSION_COUNTER reaches the preambleTransMax may be performed in accordance with the behavior specified in TS 38.321 v16.7.0 section 5.1.3, at least as one possibility.

In some instances, it may be possible that during PSCell handover for EN-DC to EN-DC, for the RACH transmission on the new (target) PSCell, the UE can change whether to prioritize NR PSCell RACH or LTE PCell RACH when these RACH opportunities are colliding in the time domain. For example, if the PREAMBLE_TRANSMISSION_COUNTER reaches a (configured or specified) counter threshold, and the counter threshold is not greater than the parameter preambleTransMax, the UE may prioritize NR PSCell RACH over LTE PCell RACH when they are colliding in the time domain. Otherwise, the UE may prioritize LTE PCell RACH over NR PSCell RACH when they are colliding in the time domain.

Another consideration for NR PSCell handover from EN-DC to EN-DC on an unlicensed frequency band may relate to the T304 timer. For example, in 3GPP TS 36.133 v. 17.4.0 section 7.31A.2 (PSCell addition on NR-U), it may be defined that the PSCell addition delay including the potential extensions caused by L1, L2, and L3 is limited by the T304 timer. The T304 timer may be further defined in 3GPP TS 38.331 v.16.7.0, at least in some instances. Once a NR-U PSCell addition reaches T304 due to LBT failure, it may be important to provide a framework for performing RF re-tuning from the primary secondary component carrier (PSCC).

As one possibility if the timer T304 expires (reaches expiry) for PSCell addition (e.g., due to RACH delay based on LBT failure) during NR PSCell handover from EN-DC to EN-DC, a UE may perform RF re-tuning to leave the PSCC, and the timing to perform such RF re-tuning may be on symbols which are not overlapped with new LTE PCell control/data channel, LTE PCell RACH, or downlink or uplink reference signals (e.g., the UE would avoid RF interruption to the PCell connection). The UE may coordinate between the PCell and the target PSCell to achieve such no-interruption RF re-tuning.

As another possibility if the timer T304 expires (reaches expiry) for PSCell addition (e.g., due to RACH delay based on LBT failure) during NR PSCell handover from EN-DC to EN-DC, a UE may perform RF re-tuning to leave the PSCC, and the timing to perform such RF re-tuning may be on symbols which are not overlapped with new LTE PCell RACH (e.g., the UE would avoid RF interruption to the PCell RACH, but interruption to data/control channel and downlink/uplink reference signals may be performed). The UE may coordinate between the PCell and the target PSCell to achieve such no-RACH-interruption RF re-tuning.

In some instances, the UE may transmit a PSCell addition failure message to the network prior to performing such RF, re-tuning, then may perform RF re-tuning using either of the timing frameworks described previously herein, among various possibilities.

In the following further exemplary embodiments are provided.

One set of embodiments may include a method, comprising: by a wireless device: establishing a dual connectivity cellular link with a cellular network via at least a first cell and a second cell, wherein the first cell is a primary cell of a master cell group, wherein the second cell is a primary cell of a secondary cell group; receiving an indication to perform handover of the primary cell of the master cell group from the first cell to a third cell, wherein the third cell is in a licensed frequency band, and of the primary cell of the secondary cell group from the second cell to a fourth cell, wherein the fourth cell is in an unlicensed frequency band; determining whether to increase a preamble transmission counter for a physical random access channel (PRACH) occasion on the fourth cell if the PRACH occasion conflicts in a time domain with a PRACH transmission on the third cell; and determining whether to increase the preamble transmission counter for a PRACH occasion on the fourth cell if the PRACH occasion is unavailable for PRACH transmission due to an unsuccessful uplink listen before talk procedure.

According to some embodiments, whether to increase the preamble transmission counter for a PRACH occasion on the fourth cell if the PRACH occasion conflicts in the time domain with a PRACH transmission on the third cell is determined based at least in part on configuration information received from the cellular network.

According to some embodiments, whether to increase the preamble transmission counter for a PRACH occasion on the fourth cell if the PRACH occasion conflicts in the time domain with a PRACH transmission on the third cell is determined based at least in part on one or more third generation partnership project (3GPP) technical specifications.

According to some embodiments, whether to increase the preamble transmission counter for a PRACH occasion on the fourth cell if the PRACH occasion is unavailable for PRACH transmission due to an unsuccessful uplink listen before talk procedure is determined based at least in part on configuration information received from the cellular network.

According to some embodiments, whether to increase the preamble transmission counter for a PRACH occasion on the fourth cell if the PRACH occasion is unavailable for PRACH transmission due to an unsuccessful uplink listen before talk procedure is determined based at least in part on one or more third generation partnership project (3GPP) technical specifications.

According to some embodiments, the method further comprises: determining whether to prioritize PRACH transmission on the third cell or PRACH transmission on the fourth cell if a PRACH occasion for the third cell conflicts in the time domain with a PRACH occasion on the fourth cell based at least in part on a current value of the preamble transmission counter.

According to some embodiments, PRACH transmission on the third cell is prioritized over PRACH transmission on the fourth cell when a PRACH occasion for the third cell conflicts in the time domain with a PRACH occasion for the fourth cell if the current value of the preamble transmission counter is less than a counter threshold, wherein PRACH transmission on the fourth cell is prioritized over PRACH transmission on the third cell when a PRACH occasion for the third cell conflicts in the time domain with a PRACH occasion for the fourth cell if the current value of the preamble transmission counter is equal to or greater than the counter threshold, wherein a value of the counter threshold is less than a value configured as a maximum number of random access preamble transmissions.

According to some embodiments, the method further comprises: determining that a timer associated with the handover of the primary cell of the secondary cell group from the second cell to the fourth cell has reached expiry; and determining to perform radio frequency re-tuning from the fourth cell on symbols that are not overlapped with control or data channels, RACH occasions, or downlink or uplink reference signals of the third cell.

According to some embodiments, the method further comprises: determining that a timer associated with the handover of the primary cell of the secondary cell group from the second cell to the fourth cell has reached expiry; and determining to perform radio frequency re-tuning from the fourth cell on symbols that are not overlapped with RACH occasions of the third cell.

According to some embodiments, the method further comprises: transmitting a message to the cellular network indicating that addition of the fourth cell as the primary cell of the secondary cell group has failed, wherein the radio frequency re-tuning from the fourth cell is performed after the message indicating that addition of the fourth cell as the primary cell of the secondary cell group has failed is transmitted to the cellular network.

Another set of embodiments may include a wireless device, comprising: one or more processors; and a memory having instructions stored thereon, which when executed by the one or more processors, perform steps of the method of any of the preceding examples.

Still another set of embodiments may include a method, comprising: by a cellular base station: establishing a cellular link with a wireless device; providing configuration information to the wireless device for dual connectivity handover, wherein the dual connectivity handover includes handover of a primary cell of a master cell group from a source primary cell to a target primary cell, wherein the target primary cell is in a licensed frequency band, wherein the dual connectivity handover also includes handover of a primary cell of a secondary cell group from a source primary secondary cell to a target primary secondary cell, wherein the target primary secondary cell is in an unlicensed frequency band, wherein the configuration information for dual connectivity handover indicates whether to increase a preamble transmission counter for a physical random access channel (PRACH) occasion on the target primary secondary cell if the PRACH occasion is unavailable due to a conflict in a time domain with a PRACH transmission on the target primary cell, wherein the configuration information for dual connectivity handover indicates whether to increase the preamble transmission counter for a PRACH occasion on the target primary secondary cell if the PRACH occasion is unavailable for PRACH transmission due to an unsuccessful uplink listen before talk procedure.

According to some embodiments, the configuration information for dual connectivity handover includes a counter threshold configured for use in determining whether to prioritize PRACH transmission on the target primary cell or PRACH transmission on the target primary secondary cell if a PRACH occasion for the target primary cell conflicts in the time domain with a PRACH occasion for the target primary secondary cell.

According to some embodiments, PRACH transmission on the target primary cell is prioritized over PRACH transmission on the target primary secondary cell when a PRACH occasion for the target primary cell conflicts in the time domain with a PRACH occasion for the target primary secondary cell if a current value of the preamble transmission counter is less than the counter threshold, wherein PRACH transmission on target primary secondary cell is prioritized over PRACH transmission on the target primary cell when a PRACH occasion for the target primary cell conflicts in the time domain with a PRACH occasion for the target primary secondary cell if the current value of the preamble transmission counter is equal to or greater than the counter threshold, wherein a value of the counter threshold is less than a value configured as a maximum number of random access preamble transmissions.

According to some embodiments, the method further comprises: receiving a message from the wireless device indicating that primary secondary cell addition failure has occurred.

According to some embodiments, the method further comprises: providing configuration information indicating allowed symbol timing for performing radio frequency re-tuning from the target primary secondary cell when primary secondary cell addition failure occurs.

According to some embodiments, the configuration information indicating allowed symbol timing for performing radio frequency re-tuning from the target primary secondary cell when primary secondary cell addition failure occurs indicates that the radio frequency re-tuning from the target primary secondary cell can be performed on symbols that are not overlapped with control or data channels, random access channel (RACH) occasions, or downlink or uplink reference signals of the target primary cell.

According to some embodiments, the configuration information indicating allowed symbol timing for performing radio frequency re-tuning from the target primary secondary cell when primary secondary cell addition failure occurs indicates that the radio frequency re-tuning from the target primary secondary cell can be performed on symbols that are not overlapped with random access channel (RACH) occasions of the target primary cell.

Yet another set of embodiments may include a cellular base station, comprising: one or more processors; and a memory having instructions stored thereon, which when executed by the one or more processors, perform steps of the method of any of the preceding examples.

A still further set of embodiments may include a computer program product, comprising computer instructions which, when executed by one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
communicating via a dual connectivity cellular link with a cellular network via at least a first cell and a second cell, wherein the first cell is a primary cell of a master cell group, wherein the second cell is a primary cell of a secondary cell group;
receiving an indication to perform handover of the primary cell of the master cell group from the first cell to a third cell, wherein the third cell is in a licensed frequency band, and of the primary cell of the secondary cell group from the second cell to a fourth cell, wherein the fourth cell is in an unlicensed frequency band;
determining whether to increase a preamble transmission counter for a physical random access channel (PRACH) occasion on the fourth cell based at least in part on whether the PRACH occasion conflicts in a time domain with a PRACH transmission on the third cell; and
determining whether to increase the preamble transmission counter for a PRACH occasion on the fourth cell based at least in part on whether the PRACH occasion is unavailable for PRACH transmission due to an unsuccessful uplink listen before talk procedure.

2. The method of claim 1,
wherein whether to increase the preamble transmission counter for a PRACH occasion on the fourth cell based at least in part on whether the PRACH occasion conflicts in the time domain with a PRACH transmission on the third cell is determined based at least in part on configuration information received from the cellular network.

3. The method of claim 1,
wherein whether to increase the preamble transmission counter for a PRACH occasion on the fourth cell based at least in part on whether the PRACH occasion conflicts in the time domain with a PRACH transmission on the third cell is determined based at least in part on one or more third generation partnership project (3GPP) technical specifications.

4. The method claim 1,
wherein whether to increase the preamble transmission counter for a PRACH occasion on the fourth cell based at least in part on whether the PRACH occasion is unavailable for PRACH transmission due to an unsuccessful uplink listen before talk procedure is determined based at least in part on configuration information received from the cellular network.

5. The method claim 1,
wherein whether to increase the preamble transmission counter for a PRACH occasion on the fourth cell based at least in part on whether the PRACH occasion is unavailable for PRACH transmission due to an unsuccessful uplink listen before talk procedure is determined based at least in part on one or more third generation partnership project (3GPP) technical specifications.

6. The method of claim 1, wherein the method further comprises:
determining whether to prioritize PRACH transmission on the third cell or PRACH transmission on the fourth cell based at least in part on whether a PRACH occasion for the third cell conflicts in the time domain with a PRACH occasion on the fourth cell based at least in part on a current value of the preamble transmission counter.

7. The method of claim 6, wherein:
PRACH transmission on the third cell is prioritized over PRACH transmission on the fourth cell when a PRACH occasion for the third cell conflicts in the time domain with a PRACH occasion for the fourth cell if the current value of the preamble transmission counter is less than a counter threshold;
PRACH transmission on the fourth cell is prioritized over PRACH transmission on the third cell when a PRACH occasion for the third cell conflicts in the time domain with a PRACH occasion for the fourth cell if the current value of the preamble transmission counter is equal to or greater than the counter threshold; and
a value of the counter threshold is less than a value configured as a maximum number of random access preamble transmissions.

8. The method of claim 1, wherein the method further comprises:
determining that a timer associated with the handover of the primary cell of the secondary cell group from the second cell to the fourth cell has reached expiry; and
determining to perform radio frequency re-tuning from the fourth cell on symbols that are not overlapped with control or data channels, RACH occasions, or downlink or uplink reference signals of the third cell.

9. The method of claim 1, wherein the method further comprises:
determining that a timer associated with the handover of the primary cell of the secondary cell group from the second cell to the fourth cell has reached expiry; and
determining to perform radio frequency re-tuning from the fourth cell on symbols that are not overlapped with RACH occasions of the third cell.

10. The method of claim 9, wherein the method further comprises:
transmitting a message to the cellular network indicating that addition of the fourth cell as the primary cell of the secondary cell group has failed,
wherein the radio frequency re-tuning from the fourth cell is performed after the message indicating that addition of the fourth cell as the primary cell of the secondary cell group has failed is transmitted to the cellular network.

11.-20. (canceled)

21. An apparatus, comprising:
a processor configured to, when executing instructions stored in a memory, perform operations comprising:
communicating via a dual connectivity cellular link with a cellular network via at least a first cell and a second cell, wherein the first cell is a primary cell of a master cell group, wherein the second cell is a primary cell of a secondary cell group;
receiving an indication to perform handover of claims the primary cell of the master cell group from the first cell to a third cell, wherein the third cell is in a licensed frequency band, and of the primary cell of the secondary cell group from the second cell to a fourth cell, wherein the fourth cell is in an unlicensed frequency band;
increasing a preamble transmission counter for a physical random access channel (PRACH) occasion on the fourth cell based at least in part on whether the PRACH occasion conflicts in a time domain with a PRACH transmission on the third cell; and
determining whether to increase the preamble transmission counter for a PRACH occasion on the fourth cell based at least in part on whether the PRACH occasion is unavailable for PRACH transmission due to an unsuccessful uplink listen before talk procedure.

22. The apparatus of claim 21, the operations further comprising: determining that a timer associated with the handover of the primary cell of the secondary cell group from the second cell to the fourth cell has reached expiry; and
determining to perform radio frequency re-tuning from the fourth cell on symbols that are not overlapped with control or data channels, RACH occasions, or downlink or uplink reference signals of the third cell.

23. The apparatus of claim 22, the operations further comprising: transmitting a message to the cellular network indicating that addition of the fourth cell as the primary cell of the secondary cell group has failed, wherein the radio frequency re-tuning from the fourth cell is performed after the message indicating that addition of the fourth cell as the primary cell of the secondary cell group has failed is transmitted to the cellular network.

24. A method, comprising:
by a cellular base station:
establishing a cellular link with a wireless device;
providing configuration information to the wireless device for dual connectivity handover, wherein the dual connectivity handover includes handover of a primary cell of a master cell group from a source primary cell to a target primary cell, wherein the target primary cell is in a licensed frequency band, wherein the dual connectivity handover also includes handover of a primary cell of a secondary cell group from a source primary secondary cell to a target primary secondary cell, wherein the target primary secondary cell is in an unlicensed frequency band;
wherein the configuration information for dual connectivity handover indicates whether to increase a preamble transmission counter for a physical random access channel (PRACH) occasion on the target primary secondary cell based at least in part on whether the PRACH occasion is unavailable due to a conflict in a time domain with a PRACH transmission on the target primary cell; and
wherein the configuration information for dual connectivity handover indicates whether to increase the preamble transmission counter for a PRACH occasion on the target primary secondary cell based at least in part on whether the PRACH occasion is unavailable for PRACH transmission due to an unsuccessful uplink listen before talk procedure.

25. The method of claim 24,
wherein the configuration information for dual connectivity handover includes a counter threshold configured for use in determining whether to prioritize PRACH transmission on the target primary cell or PRACH transmission on the target primary secondary cell based at least in part on whether a PRACH occasion for the target primary cell conflicts in the time domain with a PRACH occasion for the target primary secondary cell.

26. The method of claim 25,
wherein PRACH transmission on the target primary cell is prioritized over PRACH transmission on the target primary secondary cell when a PRACH occasion for the target primary cell conflicts in the time domain with a PRACH occasion for the target primary secondary cell based at least in part on whether a current value of the preamble transmission counter is less than the counter threshold;
PRACH transmission on target primary secondary cell is prioritized over PRACH transmission on the target primary cell when a PRACH occasion for the target primary cell conflicts in the time domain with a PRACH occasion for the target primary secondary cell if the current value of the preamble transmission counter is equal to or greater than the counter threshold; and
a value of the counter threshold is less than a value configured as a maximum number of random access preamble transmissions.

27. The method of 24, wherein the method further comprises:
receiving a message from the wireless device indicating that primary secondary cell addition failure has occurred.

28. The method of 24, wherein the method further comprises:
providing configuration information indicating allowed symbol timing for performing radio frequency re-tuning from the target primary secondary cell when primary secondary cell addition failure occurs.

29. The method of claim 28,
wherein the configuration information indicating allowed symbol timing for performing radio frequency re-tuning from the target primary secondary cell when primary secondary cell addition failure occurs indicates that the radio frequency re-tuning from the target primary secondary cell can be performed on symbols that are not overlapped with control or data channels, random access channel (RACH) occasions, or downlink or uplink reference signals of the target primary cell.

30. The method of claim 28,
wherein the configuration information indicating allowed symbol timing for performing radio frequency re-tuning from the target primary secondary cell when primary secondary cell addition failure occurs indicates that the radio frequency re-tuning from the target primary secondary cell can be performed on symbols that are not overlapped with random access channel (RACH) occasions of the target primary cell.
